(19) United States
(12) Patent Application Publication
(10) Pub. No.: US 2026/0140805 A1
(43) Pub. Date: May 21, 2026

(54) METHOD FOR DETECTING AN ERROR THAT OCCURRED DURING DATA PROCESSING

(71) Applicant: Robert Bosch GmbH, Stuttgart (DE)

(72) Inventors: Vera Schumacher, Gerlingen (DE); Peter Schneider, Holzgerlingen (DE); Sascha Guebner, Bodenburg (DE)

(21) Appl. No.: 19/388,140

(22) Filed: Nov. 13, 2025

(30) Foreign Application Priority Data
Nov. 19, 2024 (DE) 10 2024 211 100.7

(51) Int. Cl. G06F 11/07

(52) U.S. Cl. CPC G06F 11/0751; G06F 11/0715

(57) ABSTRACT

A method for detecting an error that occurred during data processing, using a computer-implemented monitoring instance. The method provides for a plurality of application software instances executed independently of one another on a non-intrinsically safe computer platform, e.g., for controlling one motor vehicle in each case, to be entangled so that, in the event of a critical error in one application software instance, a reliable and timely error response is triggered in all application software instances. A system for detecting an error that occurred during data processing, to a computer program and a machine-readable storage medium is also described.

### CROSS REFERENCE

The present application claims the benefit under 35 U.S.C. § 119 of Germany Patent Application No. DE 10 2024 211 100.7 filed on Nov. 19, 2024, which is expressly incorporated herein by reference in its entirety.

### FIELD

The present invention relates to a method and a system for detecting an error that occurred during data processing, to a computer program, and to a machine-readable storage medium.

### BACKGROUND INFORMATION

Germany Patent Application No. DE 10 2007 040 721 A1 describes a data processing arrangement.

Germany Patent Application No. DE 10 2010 037 457 A1 describes a data processing method for providing a value for ascertaining whether an error has occurred during an execution of a program.

Germany Patent Application No. DE 10 2014 117 971 A1 describes a data processing method for ascertaining whether an error has occurred during an execution of a program.

U.S. Pat. No. 9,304,872 B2 describes a method for providing a value in order to determine whether an error has occurred during an execution of a program.

### SUMMARY

An object of the present invention is to provide a concept for detecting an error that occurred during data processing.

This object may be achieved by means of certain features of the present invention. Advantageous embodiments of the present invention are disclosed herein.

According to a first aspect of the present invention, a method for detecting an error that occurred during data processing, using a computer-implemented monitoring instance is provided. According to an example embodiment of the present invention, the method comprises the following steps:
processing, by each of at least one application software instance executed by at least one computer platform, input data in order to generate respective payload data for at least one receiver in each case,
receiving, by the monitoring instance, monitoring-based monitoring data from at least the at least one computer platform and the at least one application software instance,
calculating, by the monitoring instance, a value of a response key based on a value of a challenge key and the monitoring data,
sending, by the monitoring instance, the calculated value of the response key to the at least one application software instance,
receiving, by each of the at least one application software instance, the calculated value of the response key,
at least partially encrypting, by each of the at least one application software instance, a message, containing the respective generated payload data, for the respective receiver,
using the respective received value of the response key,
sending, by each of the at least one application software instance, the respective, at least partially encrypted message to the respective receiver,
receiving, by the respective receiver, the respective, at least partially encrypted message,
calculating, by the respective receiver, a target value of the response key under the assumption that no error has occurred during the monitoring,
decrypting, by the respective receiver, the respective, at least partially encrypted message, using the self-calculated target value of the response key,
checking, by the respective receiver, the decrypted message in order to detect an error that occurred during the data processing.

According to a second aspect of the present invention, a system for detecting an error that occurred during data processing is provided. According to an example embodiment of the present invention, the system comprises:
at least one computer platform, in each case configured to execute at least one application software instance,
a computer-implemented monitoring instance,
at least one receiver,
wherein the system is configured to perform all steps of the method according to the first aspect.

According to a third aspect of the present invention, a computer program is provided. According to an example embodiment of the present invention, the computer program includes commands that, when the computer program is executed by the system according to the second aspect of the present invention, cause the system to perform a method according to the first aspect of the present invention.

According to a fourth aspect of the present invention, a machine-readable storage medium is provided, on which the computer program according to the third aspect of the present invention is stored.

The present invention is based on and includes the finding that the above object is achieved by providing a monitoring instance implemented independently of the application software instance(s).

Here, “implemented independently” refers in particular to the independence of the monitoring instance from the application software instance(s). This means, in particular, that the monitoring instance (as explained below and shown in FIG. 4) can, for example, run on the same computer platform as the application software instance(s). The monitoring instance can, for example, be executed by a different computer platform than the application software instance(s). This means, in particular, that the monitoring instance and the application software instance(s) are executed by a common or by a plurality of computer platforms. The important thing is that the monitoring instance is independent of the application software instance(s).

If the term “monitoring instance” is used by itself in the description, i.e., without the term “computer-implemented,” it should always be understood as “computer-implemented monitoring instance.” This means that the monitoring instance is a computer-implemented monitoring instance.

This monitoring instance receives monitoring data from at least the at least one computer platform and the at least one application software instance, i.e., from the at least one computer platform and/or the at least one application software instance. The monitoring instance uses these monitoring data in order to calculate a value of a response key based on a value of a challenge key. The monitoring instance sends the calculated value of the response key to the at least one application software instance.

All application software instances thus receive a value of a response key that differs from a value of a response key that would be calculated if no error had occurred. This is true even if all other application software instances have calculated correctly, i.e., if no error has occurred in the other application software instances, for example.

All application software instances thus use this differing value of the response key to at least partially encrypt a message that comprises the respective generated payload data.

In each case, the respective the at least one application software instance sends this at least partially encrypted message to the respective receiver.

On the receiver side, a target value of the response key is calculated for decryption under the assumption that no error has occurred during the data processing. Since, according to the explanations by way of example above, an error has occurred in one of the application software instances, the target value of the response key no longer matches the differing value of the response key calculated above, so that either the message cannot be decrypted using the target value of the response key or it can be decrypted, but the decrypted message makes no sense from the receiver's point of view, so that it can be detected therefrom that an error has occurred during the data processing.

In the error-free case, however, the calculated value of the response key matches the target value of the response key, so that the at least partially encrypted message can be decrypted, or the decrypted message makes sense from the receiver's point of view.

This makes it possible to efficiently detect an error that occurred during data processing.

Furthermore, all receivers can detect the error and thus trigger appropriate error responses, even if an error has occurred in only one of the application software instances or only in one of the computer platforms. The reason, as already explained above, is that a single error is sufficient to calculate a value of a response key for all application software instances that differs from the target value of the response key, so that meaningful decryption no longer functions.

The present invention described here thus ensures, in particular, that a plurality of application software instances executed independently of one another on a non-intrinsically safe computer platform, for example application software instances for controlling one motor vehicle in each case, are entangled so that, in the event of a (critical) error in one application software instance, a reliable and timely error response can be triggered in all application software instances.

Thus, this results, in particular, in a technical advantage that a concept for efficiently detecting an error that occurred during data processing is provided.

Furthermore, a central aggregation of errors, which is reliable because it is mathematically entangled with the application software and self-monitored, with a real-time capable error response can be made possible.

Furthermore, efficient integration of typically application-software-independent computer platform monitoring into existing error signaling paths can be made possible, for example, via message checksums. This makes efficient implementation in existing systems possible.

In one example embodiment of the method of the present invention, the monitoring instance carries out self-monitoring, wherein the monitoring instance calculates the value of the response key based on the self-monitoring, wherein the respective receiver calculates the respective target value of the response key under the assumption that no error has occurred during the self-monitoring.

This results, for example, in a technical advantage that even an error in the monitoring instance leads to decryption no longer functioning properly on the receiver side, so that errors in the monitoring instance can also trigger an error response on the receiver side.

In one example embodiment of the method, the self-monitoring comprises carrying out a program flow control regarding the calculation of the value of the response key.

This results, for example, in the technical advantage of providing particularly useful self-monitoring that is easy-to-integrate, since it is software-based.

For example, the monitoring instance calculates the value of a response key based on a result of the program flow control.

In one embodiment of the method of the present invention, the monitoring data comprise one or more elements from the following group of data: diagnostic data of the computer platform and/or memory utilization, CPU utilization, GPU utilization, temperature, thermal budget, storage space, network connection quality, SMART status of one or more hard drives, application-software-instance-specific internal monitoring data.

This results, for example, in a technical advantage that particularly suitable monitoring data can be provided.

The above-described self-monitoring by the monitoring instance can, for example, comprise the monitoring instance ascertaining its own monitoring data, as explained above by way of example, wherein it is provided, for example, that the monitoring instance calculates the value of the response key based on its own monitoring data.

For example, the monitoring instance's own monitoring data thus comprise one or more elements from the following group of data: diagnostic data of the monitoring instance and/or memory utilization, CPU utilization, GPU utilization, temperature, thermal budget, storage space, network connection quality, SMART status of one or more hard drives.

In one example embodiment of the method of the present invention, the monitoring instance compares the monitoring data with reference monitoring data, wherein the monitoring instance calculates the value of the response key based on the comparison.

This results, for example, in a technical advantage that a deviation from a reference state can be efficiently detected through the comparison, so that the value of the response key can be efficiently calculated.

In one example embodiment of the method of the present invention, based on the monitoring data, the monitoring instance ascertains whether a critical state has already occurred and/or whether a critical state will occur, wherein the monitoring instance calculates the value of the response key based on a result of the ascertainment, wherein the respective receiver calculates the respective target value of the response key under the assumption that no critical state has already occurred and/or that no critical state will occur.

This results, for example, in a technical advantage that a critical state that has already occurred or a potentially occurring critical state causes the value of the response key to deviate from the target values of the response key that were calculated by the receivers.

By ascertaining, for example, whether a critical state will occur, an error response can be generated even before the critical state occurs.

In one example embodiment of the method of the present invention, the respective, at least partial encryption, by the at least one application software instance, of the message containing the respective generated payload data for the respective receiver comprises that the payload data are encrypted at least partially using the respective received value of the response key and/or that a checksum of the payload data is encrypted at least partially using the respective received value of the response key.

This results, for example, in a technical advantage that particularly suitable data, here the payload data or the checksum, can be encrypted.

In one example embodiment of the method of the present invention, each application software instance has already at least partially pre-encrypted the respective message before the respective message is at least partially encrypted using the respective received value of the response key, wherein the pre-encrypted portion is decrypted in each case by the respective receiver before checking the message.

This results, for example, in a technical advantage that the at least partial pre-encryption provides special protection for the message.

In one example embodiment of the method of the present invention, the monitoring instance is implemented on the computer platform or on another computer platform.

This results, for example, in a technical advantage that the monitoring instance can be implemented efficiently.

In one example embodiment of the method of the present invention, the respective receiver is implemented in each case separately in a motor vehicle or in a robot.

This results, for example, in a technical advantage that the respective receiver is implemented efficiently.

The method according to the first aspect of the present invention is carried out, for example, by means of the system according to the second aspect of the present invention.

Method features result analogously from corresponding system features, and vice versa. Statements made in connection with the method apply analogously to the system, and vice versa.

Technical functionalities and technical features of the system result analogously from corresponding technical features of the method and corresponding technical functionalities of the method, and vice versa.

The system is, for example, programmatically configured to execute the computer program.

The method is, for example, a computer-implemented method.

The wording “at least one” means “one or more.”

This means, for example, that one or more computer platforms can be provided.

This means, for example, that one or more application software instances can be provided.

For example, a computer platform executes one or more application software instances or is configured to do so.

This means, for example, that one or more receivers are provided.

For example, a receiver is assigned application software. This means, for example, that each receiver is assigned its own application software instance.

The embodiments and exemplary embodiments described here can be combined with one another in any way even if this is not explicitly described.

The present invention is explained in more detail below using preferred exemplary embodiments.

### BRIEF DESCRIPTION OF THE DRAWINGS

FIG. 1 shows a flowchart of a method for detecting an error that occurred during data processing, according to an example embodiment of the present invention.

FIG. 2 shows a system for detecting an error that occurred during data processing, according to an example embodiment of the present invention.

FIG. 3 shows a machine-readable storage medium, according to an example embodiment of the present invention.

FIG. 4 shows a first block diagram according to an example embodiment of the present invention.

FIG. 5 shows a second block diagram according to an example embodiment of the present invention.

### DETAILED DESCRIPTION OF EXAMPLE EMBODIMENTS

In the following, the same reference signs can be used for identical features.

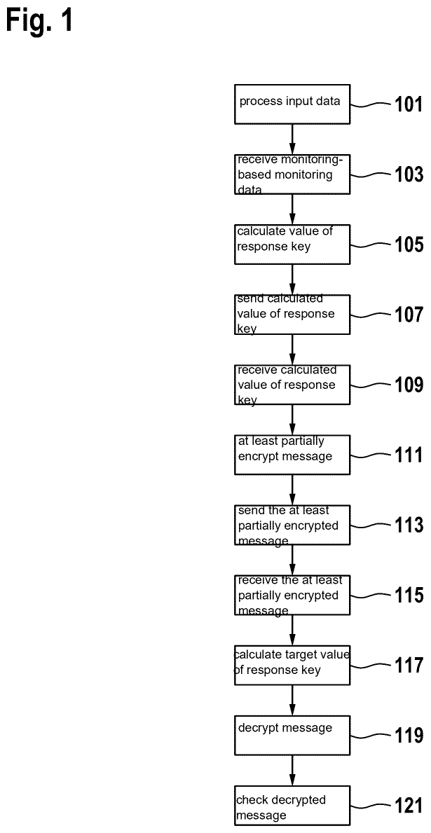

FIG. 1 shows a flowchart of a method for detecting an error that occurred during data processing, using a computer-implemented monitoring instance, comprising the following steps:
processing 101, by each of at least one application software instance executed by at least one computer platform, input data in order to generate respective payload data for at least one receiver in each case,
receiving 103, by the monitoring instance, monitoring-based monitoring data from at least the at least one computer platform and the at least one application software instance,
calculating 105, by the monitoring instance, a value of a response key based on a value of a challenge key and the monitoring data,
sending 107, by the monitoring instance, the calculated value of the response key to the at least one application software instance,
receiving 109, by each of the at least one application software instance, the calculated value of the response key,
at least partially encrypting 111, by each of the at least one application software instance, a message, containing the respective generated payload data, for the respective receiver, using the respective received value of the response key,
sending 113, by each of the at least one application software instance, the respective, at least partially encrypted message to the respective receiver,
receiving 115, by the respective receiver, the respective, at least partially encrypted message,
calculating 117, by the respective receiver, a target value of the response key under the assumption that no error has occurred during monitoring,
decrypting 119, by the respective receiver, the respective, at least partially encrypted message using the self-calculated target value of the response key,
checking 121, by the respective receiver, the decrypted message in order to detect an error that occurred during the data processing.

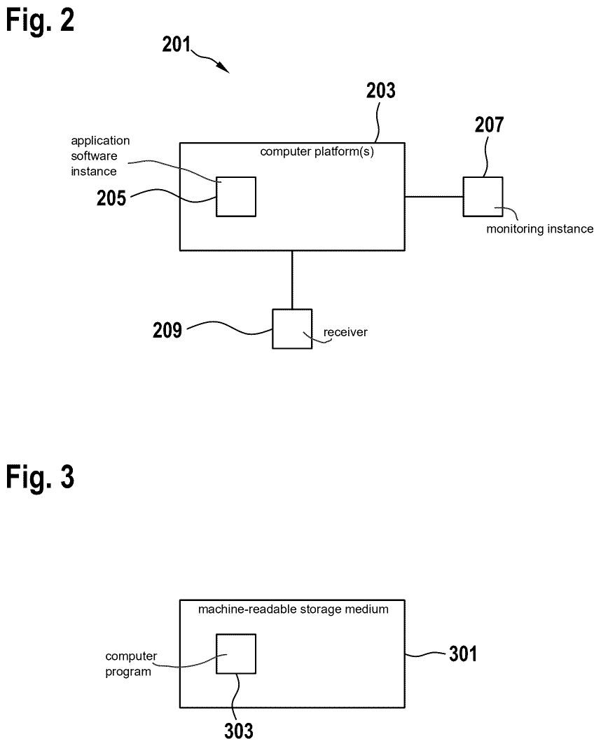

FIG. 2 shows a system 201 for detecting an error that occurred during data processing, comprising:
at least one computer platform 203, in each case configured to execute at least one application software instance 205,
a computer-implemented monitoring instance 207,
at least one receiver 209,
wherein the system is configured to perform all steps of the method according to one of the above-described embodiments.

FIG. 3 shows a machine-readable storage medium 301, on which a computer program 303 is stored. The computer program 303 comprises commands that, when the computer program 303 is executed by the system according to the second aspect, cause the system to perform a method according to the first aspect.

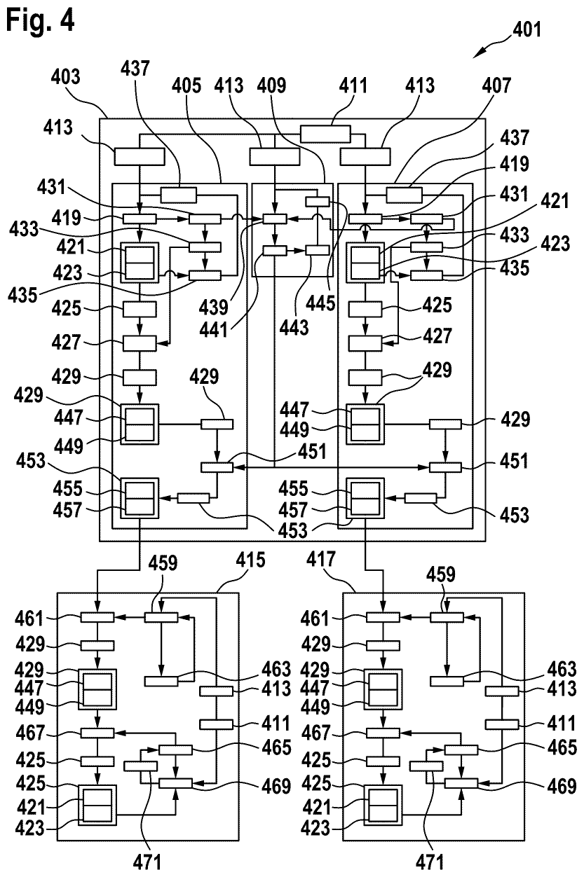

FIG. 4 shows a first block diagram 401, which by way of example illustrates the concept described here.

According to the first block diagram 401, a computer platform 403 is provided, which executes a first application software instance 405 and a second application software instance 407. Furthermore, a monitoring instance 409 is implemented in the computer platform 403.

According to a function block 411, an initialization is carried out, which comprises providing an initial value of a challenge key to the individual instances, i.e., the first application software instance 405, the second application software instance 407 and the monitoring instance 409. This initial value of the challenge key is denoted by the reference sign 413.

Furthermore, according to the first block diagram 401, a first receiver 415 and a second receiver 417 are provided. The first application software instance 405 generates payload data for the first receiver 415 from input data. The second application software instance 407 generates payload data for the second receiver 417 based on input data.

For example, the two application software instances 405, 407 are application software instances for at least partially automated driving, so that the two receivers 415, 417 are, for example, motor vehicles, or the two receivers 415, 417 are in each case implemented within a motor vehicle.

The steps or function blocks performed in each of the two application software instances 405, 407 are in each case identical, so that the block diagram 401 is described below in relation to the first application software instance 405. The same explanations apply analogously to the second application software instance 407.

The same applies to the two receivers 415, 417. Here as well, the first block diagram 405 is explained with reference to the first receiver 415. The corresponding steps or executed function blocks are identical for the two receivers 415, 417.

Accordingly, the same reference signs are used.

According to a function block 419, the first application software instance 405 processes the input data in order to generate payload data 421 for the first receiver 415. Furthermore, the first application software instance 405 calculates a checksum 423 of the payload data 421. The payload data 421 and the calculated checksum 423 are contained in a message 425.

The first application software instance pre-encrypts this message 425 according to a function block 427 in order to obtain a pre-encrypted message 429, according to which, for example, the payload data 421 and the checksum 423 are pre-encrypted.

The first application software instance 405 generates monitoring data according to a function block 431, wherein, for example, a challenge-response method can be used, for example, in order to carry out a program flow control regarding the processing of the input data according to the function block 419.

For the challenge-response method, the initial value 413 of the challenge key is used in a first step.

For example, based on the program flow control, the first application software instance 405 can calculate a value 433 of a response value, which value is used in order to pre-encrypt the message 425.

For example, the value 433 of the response key and/or the checksum 423 are used in order to calculate a value 437, to be used for a subsequent cycle, of a challenge key for the challenge-response method according to a function block 435.

The monitoring data generated in the function block 431 are sent to the monitoring instance 409 by the first application software instance 405. This first application software instance calculates a value 441 of a response key according to a function block 439, based on the initial value 413 of the challenge key and based on the monitoring data. Furthermore, the monitoring instance 409 also receives corresponding monitoring data from the second application software instance 407. These monitoring data are also used to calculate the value 441 of the response key.

The monitoring instance 409 sends the calculated value 441 of the response key to both application software instances 405, 407.

The monitoring instance 409 uses the calculated value 441 of the response key in order to calculate a next value 445 of the challenge key for a subsequent cycle according to a function block 443.

Returning to the first application software instance 405, a pre-encrypted message 429 was generated based on the value 433 of the response key, so that, for example, the payload data 421 and, for example, the checksum 423 were pre-encrypted. The pre-encrypted payload data are denoted by the reference sign 447. The pre-encrypted checksum is denoted by the reference sign 449.

The first application software instance 405 encrypts this pre-encrypted message 429 according to a function block 451 based on the value 441 of the response key in order to produce a correspondingly encrypted message 453. The re-encrypted payload data are denoted by the reference sign 455. The re-encrypted checksum is denoted by the reference sign 457. The first application software instance 405 sends this thus encrypted message 455 to the first receiver 415.

The first receiver 415 calculates a target value of the response key according to a function block 459, which target value in the error-free case should correspond to the value 441 of the response key calculated by the monitoring instance 409.

The first receiver 415 uses this calculated target value of the response key in order to decrypt the encrypted message 455 according to a function block 461 in order to obtain only the pre-encrypted message 429.

According to function block 463, the first receiver 415 calculates a next value of a challenge key, i.e., for a next cycle, in order to ascertain or calculate a new value of a response key. This takes place according to the function block 459.

Furthermore, the first receiver 415 calculates a target value of a response key according to a function block 465, which target value in the error-free case should correspond to the value 433 of the response key. The first receiver 415 uses this target value in order to decrypt the pre-encrypted message 429 again according to a function block 467 in order to obtain the decrypted message 425, so that the unencrypted payload data 421 and the unencrypted checksum 423 are available.

According to a function block 469, the first receiver 415 generates or calculates a new value of a challenge key for the next key based on the decrypted checksum 423, wherein the new value for the next cycle of the challenge key is denoted by the reference sign 471. This new value is used in order to calculate a next target value of a response key based thereon again according to the function block 465 in order to decrypt the pre-encrypted message available for the next cycle.

According to the initialization 411, the concept described here provides that the initial value 413 of the challenge key is also provided to the two receivers 415, 417, so that they can carry out the corresponding challenge-response methods in order to calculate corresponding target values of the response keys themselves.

Accordingly, the initial value 413 of the challenge key is used in order to calculate the corresponding target value of the response key according to function block 459 in order to decrypt the encrypted message 455.

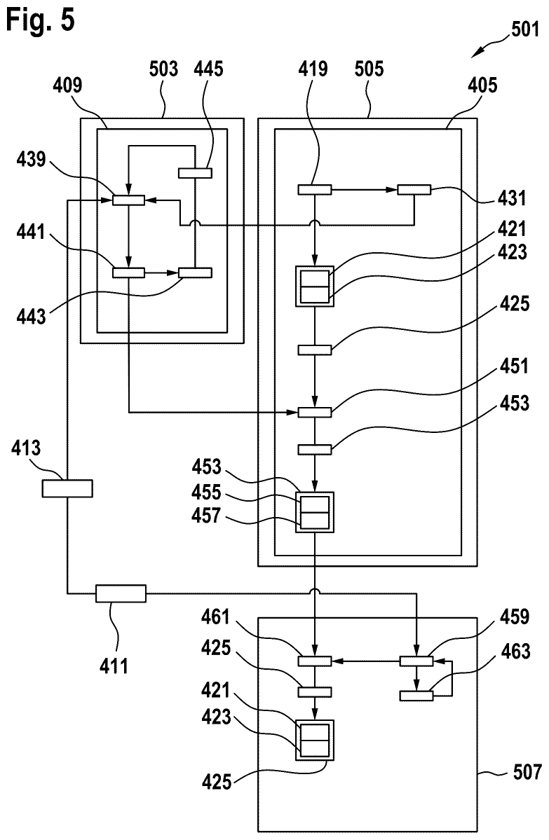

FIG. 5 shows a second block diagram 501, which by way of example illustrates the concept described here.

The same reference signs as for the first block diagram 401 are used for the same features.

One difference is that the monitoring device 409 is implemented in its own first computer platform 503. The application software instance 405 is implemented in its own second computer platform 505.

Although not shown in FIG. 5, a plurality of computer platforms can be provided, which in each case execute one or more application software instances. Nevertheless, according to the second block diagram 501, the monitoring device 409 is implemented by its own computer platform.

A further difference from block diagram 401 of FIG. 4 is that no pre-encryption takes place. Only the generated message 525 containing the payload data 421 and the checksum 423 is encrypted using the value 441 of the response key calculated by the monitoring device 409.

Since only one application software instance 405 is shown by way of example in FIG. 5, only one receiver 507 is, for example, provided for the payload data 421 calculated by the application software instance 405. Accordingly, the receiver 507 only decrypts the encrypted message 453, using the target value of the response key, which was calculated by the receiver 457 according to function block 459 under the assumption that the monitoring underlying the monitoring data was error-free.

The concept described here is explained further by way of example below with reference to exemplary features. The following abbreviations are used.

“ASW” stands for application software. If the text below refers only to “ASW,” application software instance is always implied.

If the text below refers only to a key, i.e., for example, the challenge key and/or the response key, the value of the response key or the value of the challenge key is always implied.

A signature value, as used below, is a value of a response key.

The concept described here comprises, in particular, that a plurality of application software instances (ASW instances) executed independently of one another on a non-intrinsically safe computer platform, e.g., for controlling one motor vehicle in each case, are entangled so that, in the event of a critical error in one ASW instance, a reliable and timely error response is triggered in all ASW instances.

In addition to the functionally necessary ASW instances (e.g., ASW-1 and ASW-2), a monitoring instance is implemented for this purpose, which monitoring instance implements, for example, the following functions (or a subset thereof):
cross-application monitoring of the computer platform, e.g., regarding
   memory utilization
   CPU/GPU utilization
   temperature/thermal budget
   storage space
   network connection quality
aggregation of error indicators over time; error indicators may, for example, result from:
   computer platform monitoring, e.g., SMART status of the hard drives
   ASW- and ASW-instance-specific internal monitoring,
evaluation of the aggregated error indicators regarding the necessary global or local error response (e.g., invalidate all ASW signals vs. invalidate only selected ASW signals)
reliable and timely invalidation of all selected signals for each ASW or ASW instance potentially affected by an error pattern and executed on the same computer platform.

The advantages of the concept described here include, for example, the following:
It allows for a central aggregation of errors that is reliable (because it is mathematically entangled with the application software and self-monitored), with a real-time capable error response.
It allows for efficient integration of (usually ASW-independent) platform monitoring into existing error signaling paths via message checksums, which, for example, makes retrofitting into existing systems possible.

The following describes exemplary embodiments, exemplary features, or exemplary method sequences. The individual features can be implemented individually or in combination.
A “computer platform A” executes an ASW (e.g., software for infrastructure-based control of vehicles via a V2I connection; e.g., an AVM software), which generates independent signals for a plurality of signal receivers, hereinafter referred to, for example, as “receiver 1” and “receiver 2” (e.g., infrastructure-controlled motor vehicles).
An ASW is executed in parallel instances depending on the number of signal receivers, and each ASW instance contains its own security mechanisms.
On the computer platform A, a monitoring instance, for example implemented in software, is additionally installed, which monitoring instance implements the aforementioned functions and provides the resulting results in the form of an encryption key res_i, A-HC to the ASW instances via an interface.

The following exemplary step-by-step sequence can be provided:
1) In the initialization step, a challenge-key c0 is generated, which is provided to the following software elements:
a) ASW 1 & 2 on computer platform A
b) The ASW necessary for decryption, on receiver 1 & receiver 2
2) The internal monitoring performed in the ASW instances 1 & 2 in each case generates error indicators and/or diagnostic results, which are provided to the independently executed monitoring instance.
3) The monitoring instance checks the error indicators/diagnostic results provided by the ASW 1 & 2 and compares the inputs with a pre-configured list of critical error patterns. Critical errors can, for example, include:
a) Identical error indicator as a result of identical monitoring functions performed by the ASW instances. This is an indicator of systematic errors.
b) Repeated identical error indicators (of the same ASW instance). This is an indication of a permanent/intermittent error.
c) Multiple (possibly different) error indicators within a short time interval. This is an indicator of cascaded and/or common-cause errors. A short time interval is, for example, at most 60 s or less than 60 s long. The term “common-cause error” is translated into German as “Fehler aufgrund gemeinsamer Ursache.”
4) Optionally: The monitoring instance checks the general health and “stress level” of the computer platform using cross-application and application-independent monitoring mechanisms (e.g., as described above, based on CPU utilization, memory utilization, temperature, etc.).

If a critical state is detected or predicted, this is considered a critical error indicator and accordingly affects the signature value calculated in 5).
5) The monitoring instance carries out self-monitoring, for example, in order to ensure the correct control flow in the software execution of the monitoring instance and generates
a) in the error-free case, an expected signature value res_i, A-HC that can be predicted in receiver 1 and receiver 2 using a simplified calculation
or
b) in the event of an execution error of the monitoring instance or a critical error detected in the monitoring instance, a signature value res_i, A-HC that deviates from the expected value.

The signature value depends, for example, on
the error indicators of the monitoring functions from ASW-1 & ASW-2 and/or
a cyclically changing challenge key and/or
optionally: the health status and stress level of the computer platform as ascertained by the monitoring instance.
6) The signature value res_i, A-HC is output by the monitoring instance to ASW-1 & ASW-2 and used there for the (superimposed) encryption of the (at least partially pre-encrypted) message and/or the message checksum.
7) All ASWs send their signals to their respective signal receivers (in the example: ASW-1 sends to receiver 1; ASW-2 sends to receiver 2).
8) In the signal receivers, a signature value res_i, A-HC is also calculated independently of the monitoring instance executed on computer platform A. In the error-free case (i.e., the monitoring instance was executed correctly and did not itself detect any ASW-relevant errors of the computer platform), the values of res_i, A-HC calculated on computer platform A and receiver 1 and receiver 2 are identical and can be used to decrypt the message or the message checksum.
9) In the signal receivers receiver 1 and receiver 2, it can now be checked whether the messages provided by ASW-1 and ASW-2 are consistent with one another with regard to signal (so-called payload data) and checksum (e.g., designed as CRC). If this is not the case, an appropriate error response (e.g., discarding the message) can be carried out.

The method thus ensures that, if the monitoring instance malfunctions or if critical errors are detected in the monitoring instance, all signal receivers potentially affected by the error are informed virtually simultaneously (or in the same signal processing cycle) and can initiate an appropriate error response.

In the case of an AVM (Automated Vehicle Marshalling) system, for example, all motor vehicles controlled by the infrastructure can thus be stopped virtually simultaneously if a (relevant) error occurs in an ASW instance, without compromising the clear assignment of individual ASW instances to individual motor vehicles.

This is advantageous, for example, because, in the case of an AVM system, each ASW instance is coupled with a vehicle-specific ID at the start of operation and therefore cannot communicate with other motor vehicles during operation in order to trigger time-critical and coordinated error responses. For example, in a factory AVM use case, if motor vehicles are controlled from the infrastructure along a production line “one closely behind the other” (i.e., with little distance and error response time), such an immediate and, due to the mathematical entanglement, definitely cross-instance response can be advantageous in order to control the consequences of possible and possibly variable computer latencies for the application software instances.

In the error-free case (which is usually the standard operating mode), the method ensures, without additional communication overhead or additional checks in other devices (receiver 1/2), that software such as the monitoring instance, which implements cross-ASW and/or non-functional features, is itself executed in a timely manner (e.g., cyclically) and completely.

The following application examples are mentioned below:
AVM systems that are to be installed, for example, by means of software integration on existing server clusters in a production facility.
V2X function offloading to non-intrinsically safe EDGE/cloud computer servers without changing the existing message formats; coordinated error response for all V2X message receivers of a signal generator (for example, when different V2X services generate and send messages in parallel, e.g., CPM+DENM).
Mutual integrity monitoring in a motor vehicle control unit network on the basis of message checksums and synchronized challenge keys.
Detection of errors in the control units in industrial automation.

This advantageously makes it possible, for example, to carry out a synchronized error response in multi-computer platform systems.

For example, the method also provides embodiments in which distributed systems comprising a plurality of independent computer platforms are coupled so that, in the event of a detected critical error, a signal invalidation triggered by the monitoring instance is still reliably implemented in the potentially no longer correctly executed, faulty software (here, in light of the embodiments described in connection with the figures, for example with FIG. 5, for example ASW B on computer platform B), so that a virtual dead man's switch principle with continuously changing signatures can be implemented against stuck-at errors.

For example, if two computer platforms A and B are used simultaneously (i.e., for example, B as a further copy of platform A of the simplified architecture shown in FIG. 4), it can be provided, for example, that the monitoring instance on platform A checks the results of the monitoring functions and further metrics of platform B, and vice versa. This mutual checking prevents, for example, a common error from masking both the error of a monitoring function and the monitoring instance running on the same platform.

What is claimed is:

1. A method for detecting an error that occurred during data processing, using a computer-implemented monitoring instance, comprising the following steps:
processing, by each of at least one application software instance executed by at least one computer platform, input data to generate respective payload data for a respective receiver;
receiving, by the monitoring instance, monitoring-based monitoring data from at least the at least one computer platform and the at least one application software instance;
calculating, by the monitoring instance, a value of a response key based on a value of a challenge key and the monitoring data;
sending, by the monitoring instance, the calculated value of the response key to the at least one application software instance;
receiving, by each of the at least one application software instance, the calculated value of the response key;
respective at least partially encrypting, by each of the at least one application software instance, a respective message, containing the respective generated payload data, for the respective receiver, using the respective received value of the response key;
sending, by each of the at least one application software instance, the respective at least partially encrypted message to the respective receiver;
receiving, by the respective receiver, the respective at least partially encrypted message;
calculating, by the respective receiver, a target value of the response key under the assumption that no error has occurred during the monitoring;
decrypting, by the respective receiver, the respective at least partially encrypted message using the calculated target value of the response key calculated by the respective receiver; and
checking, by the respective receiver, the decrypted respective message to detect an error that occurred during the data processing.

2. The method according to claim 1, wherein the monitoring instance carries out self-monitoring, wherein the monitoring instance calculates the value of the response key based on the self-monitoring, wherein each respective receiver calculates the respective target value of the response key under the assumption that no error has occurred during the self-monitoring.

3. The method according to claim 2, wherein the self-monitoring includes carrying out a program flow control regarding the calculation of the value of the response key.

4. The method according to claim 1, wherein the monitoring data includes one or more elements from the following group of data:
(i) diagnostic data of the computer platform and/or memory utilization, (ii) CPU utilization, (iii) GPU utilization, (iv) temperature, (v) thermal budget, (vi) storage space, (vii) network connection quality, (viii) SMART status of one or more hard drives, (ix) application-software-instance-specific internal monitoring data.

5. The method according to claim 1, wherein the monitoring instance compares the monitoring data with reference monitoring data, wherein the monitoring instance calculates the value of the response key based on the comparison.

6. The method according to claim 1, wherein, based on the monitoring data, the monitoring instance ascertains whether a critical state has already occurred and/or whether a critical state will occur, wherein the monitoring instance calculates the value of the response key based on a result of the ascertainment, wherein the respective receiver calculates the respective target value of the response key under the assumption that no critical state has already occurred and/or that no critical state will occur.

7. The method according to claim 1, wherein the respective at least partial encryption by the at least one application software instance of the message containing the respective generated payload data for the respective receiver includes that the respective payload data are encrypted at least partially using the respective received value of the response key and/or that a checksum of the respective payload data is encrypted at least partially using the respective received value of the response key.

8. The method according to claim 1, wherein each of the at least one application software instance has already at least partially pre-encrypted the respective message before the respective message is at least partially encrypted using the respective received value of the response key, wherein the at least partially pre-encrypted portion is decrypted in each case by the respective receiver before checking the respective message.

9. The method according to claim 1, wherein the monitoring instance is implemented on the computer platform or on another computer platform.

10. The method according to claim 1, wherein each of the respective receiver is implemented separately in a motor vehicle or in a robot.

11. A system for detecting an error that occurred during data processing, comprising:
at least one computer platform, each configured to execute at least one application software instance;
a computer-implemented monitoring instance; and
at least one receiver;
wherein the system is configured to detect an error that occurred during data processing, the detecting including the following steps:
processing, by each of the at least one application software instance executed by the at least one computer platform, input data to generate respective payload data for a respective receiver of the at least one receiver,
receiving, by the monitoring instance, monitoring-based monitoring data from at least the at least one computer platform and the at least one application software instance,
calculating, by the monitoring instance, a value of a response key based on a value of a challenge key and the monitoring data,
sending, by the monitoring instance, the calculated value of the response key to the at least one application software instance,
receiving, by each of the at least one application software instance, the calculated value of the response key;
respective at least partially encrypting, by each of the at least one application software instance, a respective message, containing the respective generated payload data, for the respective receiver, using the respective received value of the response key,
sending, by each of the at least one application software instance, the respective at least partially encrypted message to the respective receiver,
receiving, by the respective receiver, the respective at least partially encrypted message;
calculating, by the respective receiver, a target value of the response key under the assumption that no error has occurred during the monitoring,
decrypting, by the respective receiver, the respective at least partially encrypted message using the calculated target value of the response key calculated by the respective receiver, and
checking, by the respective receiver, the decrypted respective message to detect an error that occurred during the data processing.

12. A non-transitory machine-readable storage medium on which is stored a computer program for detecting an error that occurred during data processing, the computer program, when executed by a system including at least one computer platform, each configured to execute at least one application software instance, a computer-implemented monitoring instance, and at least one receiver, causing the system to perform the following steps:
processing, by each of the at least one application software instance executed by the at least one computer platform, input data to generate respective payload data for a respective receiver of the at least one receiver;
receiving, by the monitoring instance, monitoring-based monitoring data from at least the at least one computer platform and the at least one application software instance;
calculating, by the monitoring instance, a value of a response key based on a value of a challenge key and the monitoring data;
sending, by the monitoring instance, the calculated value of the response key to the at least one application software instance;
receiving, by each of the at least one application software instance, the calculated value of the response key;
respective at least partially encrypting, by each of the at least one application software instance, a respective message, containing the respective generated payload data, for the respective receiver, using the respective received value of the response key;
sending, by each of the at least one application software instance, the respective at least partially encrypted message to the respective receiver;
receiving, by the respective receiver, the respective at least partially encrypted message;
calculating, by the respective receiver, a target value of the response key under the assumption that no error has occurred during the monitoring;
decrypting, by the respective receiver, the respective at least partially encrypted message using the calculated target value of the response key calculated by the respective receiver; and
checking, by the respective receiver, the decrypted respective message to detect an error that occurred during the data processing.
